(19) United States
(12) Patent Application Publication
(10) Pub. No.: US 2024/0063518 A1
(43) Pub. Date: Feb. 22, 2024

(54) BATTERY

(71) Applicant: Panasonic Intellectual Property Management Co., Ltd., Osaka (JP)

(72) Inventors: MAKOTO FUJINO, Osaka (JP); KAZUHIRO MORIOKA, Osaka (JP)

(21) Appl. No.: 18/500,156

(22) Filed: Nov. 2, 2023

Related U.S. Application Data
(63) Continuation of application No. PCT/JP2022/010443, filed on Mar. 10, 2022.

(30) Foreign Application Priority Data
May 27, 2021 (JP) 2021-089481

(51) Int. Cl. H01M 50/569; H01M 10/0585; H01M 50/121; H01M 50/124

(52) U.S. Cl. CPC H01M 50/569; H01M 10/0585; H01M 50/121; H01M 50/124

(57) ABSTRACT

A battery includes: a solid-state battery section having at least one power generating element including a first electrode layer, a second electrode layer, and a first solid electrolyte layer positioned between the first electrode layer and the second electrode layer; and a structure including a second solid electrolyte layer having a first principal surface in contact with the at least one power generating element on a side surface of the solid-state battery section and a second principal surface opposite to the first principal surface, and a reference electrode in contact with the second principal surface.

### BACKGROUND

### 1. Technical Field

The present disclosure relates to a battery.

### 2. Description of the Related Art

A solid-state battery that uses a flame-retardant solid electrolyte instead of an electrolyte solution containing a flammable organic solvent for use in a battery in the related art such as a non-aqueous electrolyte solution type lithium-ion secondary battery holds high superiority in basic performance for safety. Thus, having high potential in terms of cost and energy density, such as simplification of a safety device in product development, the solid-state battery is seen as a promising next-generation battery and development competition thereof is accelerating.

In actual use of the battery, when electrical characteristics can be measured, such as the potential of each electrode such as a positive electrode and a negative electrode during operation, it is possible to know the states of the electrodes more accurately and to perform more appropriate battery control based on the measured values. This also makes it possible to improve performance such as maintenance of high-performance characteristics, safety, cycle characteristics, and storage characteristics, for example.

As a method for investigating the potential and electrochemical behavior of each single electrode, known is a three-electrode measurement method using a reference electrode. For example, “Q & A de Rikaisuru Denkikagaku no Sokutei Hou (Understanding of Electrochemical Measurement Method with Q & A)” edited by The Electrochemical Society of Japan, published by Mimizuku-sha in December 2009, p. 10 describes battery configurations of solid-state batteries having various structures in which the three-electrode measurement is possible. In addition, Japanese Unexamined Patent Application Publication No. 2013-20915 discloses a solid-state battery in which a positive electrode current collector, a positive electrode, a solid electrolyte layer, a negative electrode, and a negative electrode current collector are laminated and a third electrode is provided as a reference electrode in contact with a solid electrolyte section provided being connected with the same width as the length of the side surface of the solid electrolyte layer or the length of the side surfaces of the positive electrode, the solid electrolyte layer, and the negative electrode.

### SUMMARY

To obtain an all-solid-state battery with high performance and high energy density, it is common that the positive and negative electrodes and the solid electrolyte layer are thinned and laminated. In order to construct such an all-solid-state battery in which three-electrode measurement is possible, unlike a solution-based battery in which electrochemical contact is formed only by immersion in an electrolyte solution, the solid electrolyte layer is required to be electrochemically bonded and contacted between a cell section and a reference electrode. In a battery having a structure of the related art that allows three-electrode measurement, it is difficult to measure electrical characteristics by the three-electrode measurement because of a demand for accuracy or the like in the formation of the solid electrolyte layer for the reference electrode and the arrangement of the reference electrode. In addition, in the structure of the related art, breakage, short-circuiting, and the like are likely to occur in some cases in the reference electrode section. Therefore, there is also a demand for improved reliability in the battery in which the three-electrode measurement can be performed.

One non-limiting and exemplary embodiment provides a highly reliable battery in which electrical characteristics of electrodes can be measured.

In one general aspect, the techniques disclosed here feature a battery including: a solid-state battery section having at least one power generating element including a first electrode layer, a second electrode layer, and a first solid electrolyte layer positioned between the first electrode layer and the second electrode layer; and a structure including a second solid electrolyte layer having a first principal surface in contact with the at least one power generating element on a side surface of the solid-state battery section and a second principal surface opposite to the first principal surface, and a reference electrode in contact with the second principal surface.

According to the present disclosure, it is possible to provide a highly reliable battery in which electrical characteristics of electrodes can be measured.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view showing a schematic configuration of a battery according to an embodiment;

FIG. 2A is a side view showing the schematic configuration of the battery according to the embodiment;

FIG. 2B is a side view showing a state where a reference electrode current collector is removed from the battery shown in FIG. 2A;

FIG. 3A is a diagram for explaining a method for measuring electrical characteristics of the battery according to the embodiment;

FIG. 3B is another diagram for explaining a method for measuring electrical characteristics of the battery according to the embodiment;

FIG. 4 is a cross-sectional view showing a schematic configuration of a battery according to modified example 1 of the embodiment;

FIG. 5 is a cross-sectional view showing a schematic configuration of a battery according to modified example 2 of the embodiment;

FIG. 6 is a cross-sectional view showing a schematic configuration of a battery according to modified example 3 of the embodiment; and

FIG. 7 is a cross-sectional view showing a schematic configuration of a battery according to modified example 4 of the embodiment.

### DETAILED DESCRIPTIONS

### Outline of Present Disclosure

An aspect of the present disclosure is outlined as follows.

A battery according to an aspect of the present disclosure includes: a solid-state battery section having at least one power generating element including a first electrode layer, a second electrode layer, and a first solid electrolyte layer positioned between the first electrode layer and the second electrode layer; and a structure including a second solid electrolyte layer having a first principal surface in contact with the at least one power generating element on a side surface of the solid-state battery section and a second principal surface opposite to the first principal surface, and a reference electrode in contact with the second principal surface. Thus, electrical characteristics of electrodes can be measured, and a highly reliable battery can be provided. In addition, in plan view of the second principal surface, for example, the reference electrode may be smaller in area than the second principal surface.

Accordingly, the reference electrode is less likely to come into contact with the solid-state battery section, compared to the case where the area of the reference electrode is larger than or equal to the area of the second principal surface. For example, even when the reference electrode and the second solid electrolyte layer are pressed against the side surface of the solid-state battery section to improve the contact between the second solid electrolyte layer and the power generating element, the reference electrode is less likely to come into contact with the solid-state battery section, making short-circuiting less likely to occur. Therefore, a more highly reliable battery can be realized.

For example, the at least one power generating element may include a plurality of power generating elements, the solid-state battery section may have a structure in which the plurality of power generating elements are laminated, and the structure may further include an outer package which covers the side surface of the second solid electrolyte layer.

Thus, the second solid electrolyte layer in contact with the solid-state battery section is covered with the outer package, and the mechanical strength of the structure can be increased. Therefore, the reliability of the battery can be further improved.

For example, the outer package may have a surface facing the side surface of the solid-state battery section, and the second solid electrolyte layer may protrude from the surface.

Thus, even when the power generating element and the second solid electrolyte layer are in contact with each other, the outer package is prevented from interfering with the side surface of the solid-state battery section. Therefore, even when the side surface of the solid-state battery section has fine unevenness, for example, the contact between the power generating element and the second solid electrolyte layer can be improved. Therefore, electrochemical contact is easily formed between the power generating element and the second solid electrolyte layer.

For example, the outer package may contain insulating resin and may be in contact with the side surface of the solid-state battery section.

The side surface of the solid-state battery section often has fine unevenness derived from the material of each layer in the power generating element. A bonding anchor effect between such unevenness and the insulating resin of the outer package can improve bondability between the solid-state battery section and the structure. Therefore, the mechanical strength of the battery is enhanced, and the second solid electrolyte layer is strongly protected by the outer package. Thus, the reliability of the battery can be improved.

For example, the outer package may include a first resin layer that contains a first insulating resin and a second resin layer that contains a second insulating resin and is softer than the first resin layer. The second resin layer may be positioned between the first resin layer and the solid-state battery section and may be in contact with the side surface of the solid-state battery section.

Thus, the second resin layer, which is softer and more deformable than the first resin layer, is in contact with the side surface of the solid-state battery section. This prevents the outer package from hindering the contact between the power generating element and the second solid electrolyte layer due to deformation of the second resin layer. As a result, the contact between the power generating element and the second solid electrolyte layer can be improved. In addition, the second solid electrolyte layer can also be protected by the second resin layer in contact with the side surface of the solid-state battery section. Thus, the reliability of the battery can be improved.

For example, the plurality of power generating elements are electrically connected in parallel and laminated, and the first principal surface may be in contact with more than or equal to two of the plurality of power generating elements.

Accordingly, the first principal surface can be increased in size, and thus the contact between the power generating element and the second solid electrolyte layer can be formed on the side surface of the solid-state battery section without precise alignment. Therefore, a battery can be easily formed. In addition, since the contact area between the first principal surface and the side surface of the solid-state battery section is increased, the second solid electrolyte layer is less likely to come off the solid-state battery section. Thus, durability of the battery can be enhanced.

For example, the outer package may partially cover the second principal surface.

Thus, even when the reference electrode and the second solid electrolyte layer are pressed against the side surface of the solid-state battery section, the outer package partially covering the second principal surface can prevent the reference electrode from spreading.

For example, the structure may further include a reference electrode current collector in contact with the reference electrode, and the outer package may cover the reference electrode and the reference electrode current collector.

Accordingly, the reference electrode and the reference electrode current collector are also protected by the outer package. Thus, the mechanical strength of the structure can be further increased, and the reliability of the battery can be further improved.

For example, in plan view of the side surface of the solid-state battery section, the structure may not protrude beyond both ends of the solid-state battery section in the laminating direction of the solid-state battery section.

Thus, even when the solid-state battery section is pressurized in the laminating direction in order to maintain the performance of the power generating element, the structure hardly interferes with the pressurization, and deterioration in battery characteristics of the solid-state battery section can be suppressed.

For example, a length of the structure in the laminating direction of the solid-state battery section may be smaller than a length of the solid-state battery section in the laminating direction of the solid-state battery section.

Thus, in the laminating direction of the solid-state battery section, the structure is located on the inner side than the solid-state battery section. Therefore, even when the solid-state battery section is compressed in the laminating direction by the pressurization of the solid-state battery section in the laminating direction, the structure is less likely to hinder the compression of the solid-state battery section. Therefore, the battery characteristics of the solid-state battery section can be enhanced.

Hereinafter, embodiments will be specifically described with reference to the drawings.

The embodiments described below all illustrate comprehensive or specific examples. The numerals, shapes, materials, constituent elements, the arrangement and connections of the constituent elements, manufacturing steps, order of the manufacturing steps, and the like discussed in the following embodiments are only exemplary and are not construed to limit the present disclosure. Among the constituent elements in the following embodiments, constituent elements not described in an independent claim will be described as arbitrary constituent elements.

The drawings are schematic and not necessarily to scale. Therefore, for example, scales and the like do not necessarily match in each drawing. In addition, in each drawing, substantially the same configurations are denoted by the same reference numerals to eliminate or simplify overlapped description.

In the present specification, terms indicating the relationship between elements such as parallel and perpendicular, terms indicating the shape of elements such as a rectangle and a circle, and numerical ranges are expressions including substantially the same ranges, for example, differences of about several percent, rather than expressions indicating strict meanings only.

In the present specification and drawings, an x-axis, a y-axis, and a z-axis represent three axes of a three-dimensional orthogonal coordinate system. The x-axis and the y-axis correspond to directions parallel to principal surfaces of current collectors and each layer included in a solid-state battery section, respectively. The z-axis corresponds to a laminating direction of a plurality of power generating elements included in the solid-state battery section and to a laminating direction of each layer included in the power generating element. Also, the “laminating direction” is a direction in which the layers are laminated in the solid-state battery section unless otherwise specified, and corresponds to a direction normal to the principal surfaces of the current collectors and each layer included in the solid-state battery section.

Further, a “plan view” of a certain surface” means a view of the certain surface as seen from the front.

Also, in the present specification, the terms “above” and “below” in a battery configuration do not refer to upward (vertically upward) and downward (vertically downward) directions in absolute spatial recognition, but are rather used as terms defined by a relative positional relationship based on a laminating order in a laminated structure. In addition, the terms “above” and “below” are applied not only to a case where two constituent elements are arranged in close contact with each other but also to a case where two constituent elements are spaced apart from each other with another constituent element between the two constituent elements.

### EMBODIMENT

First, a battery according to an embodiment will be described.

### Battery Configuration

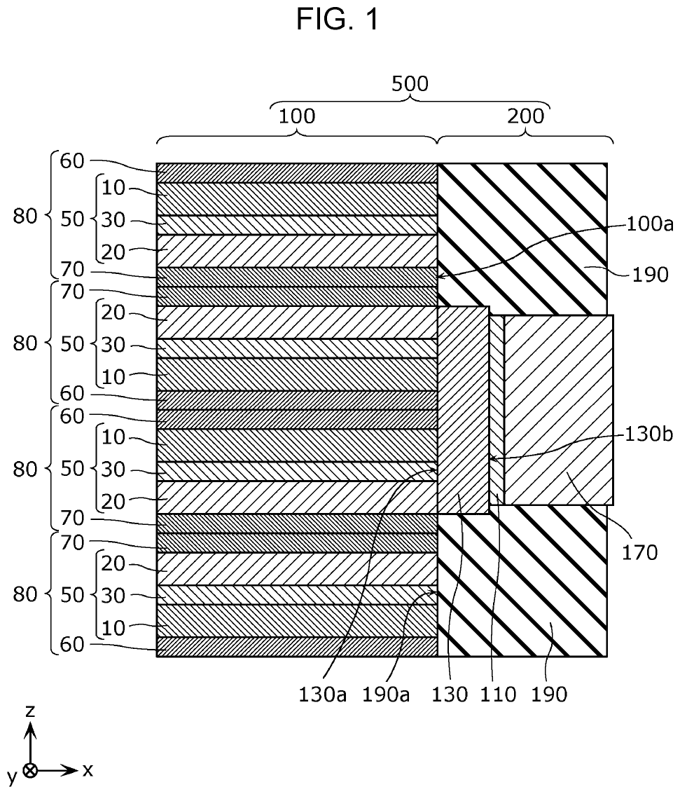

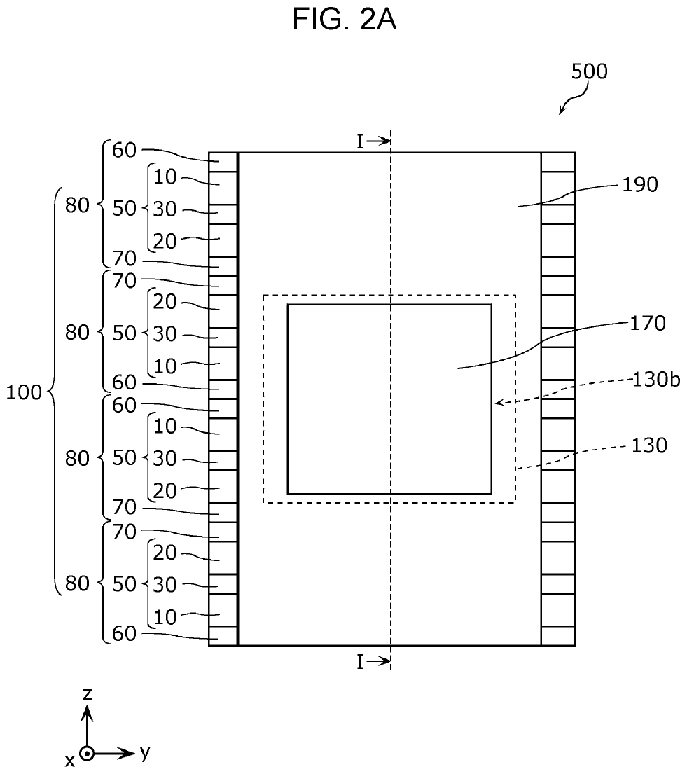

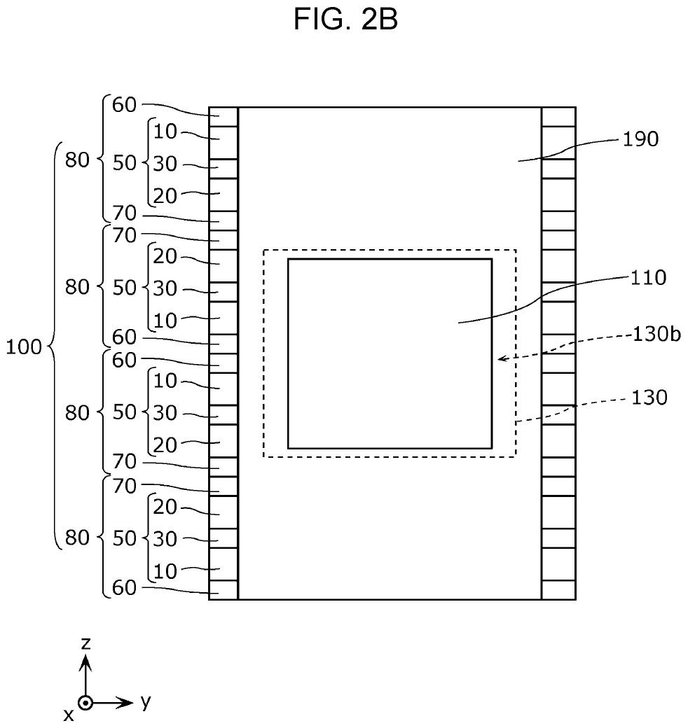

First, a configuration of the battery according to this embodiment will be described. FIG. 1 is a cross-sectional view showing a schematic configuration of a battery 500 according to this embodiment. FIG. 2A is a side view showing the schematic configuration of the battery 500 according to this embodiment. FIG. 2A is a plan view of a side surface 100a of a solid-state battery section 100. FIG. 2B is a side view showing a state where a reference electrode current collector 170 is removed from the battery 500 shown in FIG. 2A. Note that FIG. 1 shows a cross section taken along the line I-I of FIG. 2A. In FIGS. 2A and 2B, the shape of the second solid electrolyte layer 130 is indicated by dashed lines.

As shown in FIGS. 1 and 2A, the battery 500 includes the solid-state battery section 100 having a plurality of power generating elements 50 and a structure 200 having a second solid electrolyte layer 130, a reference electrode 110, a reference electrode current collector 170, and an outer package 190. The battery 500 is an all-solid-state battery, for example. The battery 500 is a coin-type, laminate-type, cylindrical or square battery, for example.

The solid-state battery section 100 has a plurality of power generating elements 50, positive electrode current collectors 60, and negative electrode current collectors 70. The solid-state battery section 100 has a structure in which the plurality of power generating elements 50 are laminated. In the example shown in FIGS. 1 and 2A, the solid-state battery section 100 has four power generating elements 50, but the number of the power generating elements 50 is not limited, and the solid-state battery section 100 may have at least one of a power generating element 50. The shape of the solid-state battery section 100 is, for example, a rectangular parallelepiped shape, a polygonal prism shape, a cylindrical shape, or the like.

The side surface 100a of the solid-state battery section 100 is in contact with the structure 200. To be more specific, the side surface 100a is in contact with a second solid electrolyte layer 130 and the outer package 190. The side surfaces of the solid-state battery section 100 and each component of the solid-state battery section 100 are surfaces that connect two principal surfaces facing each other in the solid-state battery section 100 and each component of the solid-state battery section 100, and are parallel to a laminating direction, for example. Note that the side surface 100a may be inclined with respect to the laminating direction.

The plurality of power generating elements 50 are electrically connected in parallel and laminated. Among the plurality of power generating elements 50, the power generating elements 50 adjacent to each other are laminated with the positive electrode current collector 60 or the negative electrode current collector 70 interposed therebetween. The plurality of power generating elements 50 are laminated such that the layers of the same polarity of the adjacent power generating elements 50 are electrically connected via the current collectors.

The power generating element 50 includes the positive electrode layer 10, the negative electrode layer 20 arranged opposite to the positive electrode layer 10, and a first solid electrolyte layer 30 positioned between the positive electrode layer 10 and the negative electrode layer 20. The positive electrode layer 10 is an example of a first electrode layer, and the negative electrode layer 20 is an example of a second electrode layer. In the power generating element 50, the positive electrode layer 10, the first solid electrolyte layer 30, and the negative electrode layer 20 are laminated in this order. The shape of the power generating element 50 is, for example, a rectangular parallelepiped shape, a polygonal prism shape, a cylindrical shape, or the like.

The plurality of power generating elements 50 are laminated such that the directions of arrangement of the layers in the adjacent power generating elements 50 are reversed. Therefore, in the adjacent power generating elements 50, the respective positive electrode layers 10 or the respective negative electrode layers 20 face each other without a first solid electrolyte layer 30 interposed therebetween.

In each of the plurality of power generating elements 50, a positive electrode current collector 60 is laminated on a principal surface of the positive electrode layer 10 opposite to the first solid electrolyte layer 30, and a negative electrode current collector 70 is laminated on a principal surface of the negative electrode layer 20 opposite to the first solid electrolyte layer 30. Two positive electrode current collectors 60 are disposed between the adjacent power generating elements 50 in which the respective positive electrode layers 10 are laminated so as to face each other without the first solid electrolyte layer 30 interposed therebetween. Also, two negative electrode current collectors 70 are disposed between the adjacent power generating elements 50 in which the respective negative electrode layers 20 are laminated so as to face each other without the first solid electrolyte layer 30 interposed therebetween. Thus, the layers of the same polarity are electrically connected to each other in the adjacent power generating elements 50. Note that the number of the positive electrode current collectors 60 and the negative electrode current collectors 70 disposed between the adjacent power generating elements 50 is not limited to two and may be one. That is, the positive electrode layers 10 may be laminated on both principal surfaces of one positive electrode current collector 60, and the negative electrode layers 20 may be laminated on both principal surfaces of one negative electrode current collector 70.

The positive electrode current collector 60, the negative electrode current collector 70, and the power generating element 50 positioned between the positive electrode current collector 60 and the negative electrode current collector 70 constitute a unit battery cell 80. That is, the unit battery cell 80 has the positive electrode current collector 60, the negative electrode current collector 70, and the power generating element 50. Therefore, the solid-state battery section 100 has a structure in which a plurality of unit battery cells 80 are laminated such that the electrodes of same polarities in the adjacent unit battery cells 80 are connected to each other. Thus, the plurality of unit battery cells 80 are electrically connected in parallel and laminated.

The positive electrode layer 10 is positioned between the positive electrode current collector 60 and the first solid electrolyte layer 30 and is in contact with the positive electrode current collector 60 and the first solid electrolyte layer 30. In addition, a side surface of the positive electrode layer 10 on the structure 200 side is in contact with the second solid electrolyte layer 130, specifically, the first principal surface 130a.

The positive electrode layer 10 contains at least a positive electrode active material. As a material for the positive electrode layer 10, in addition to the positive electrode active material, a positive electrode mixture containing at least one of a solid electrolyte, a conductive assistant, and a binder material may be used as necessary.

The positive electrode active material may be a known material capable of occluding and releasing (inserting and desorbing or dissolving and depositing) metal ions such as lithium ions, sodium ions, magnesium ions, potassium ions, calcium ions, and copper ions.

Examples of the positive electrode active material include a transition metal oxide containing lithium, a transition metal oxide not containing lithium, a transition metal fluoride, a polyanion material, a fluorinated polyanion material, a transition metal sulfide, a transition metal oxyfluoride, a transition metal oxysulfide, a transition metal oxynitride, and the like. When the lithium-containing transition metal oxide is used as the positive electrode active material, the manufacturing cost of the battery can be reduced and an average discharge voltage of the battery can be increased.

When the positive electrode active material is a material capable of desorbing and inserting lithium ions, lithium cobaltate composite oxide (LCO), lithium nickelate composite oxide (LNO), lithium manganate composite oxide (LMO), lithium-manganese-nickel composite oxide (LMNO), lithium-manganese-cobalt composite oxide (LMCO), lithium-nickel-cobalt composite oxide (LNCO), lithium-nickel-manganese-cobalt composite oxide (LNMCO) or the like is used, for example. Specific examples of the positive electrode active material include LiCoO₂, LiMn₂O₄, Li₂NiMn₃O₈, LiVO₂, LiCrO₂, LiFePO₄, LiCoPO₄, LiNiO₂, LiNi_{1/3}Co_{1/3}Mn_{1/3}O₂, LiNiₓMn_{y}Al_{z}O₂, LiNiₓCo_{y}Mn_{z}, LiNiₓCo_{y}Al_{z}, and the like.

As the solid electrolyte, a known material may be used that conducts metal ions such as lithium ions, sodium ions, magnesium ions, potassium ions, calcium ions, copper ions or silver ions, or protons or the like. As the solid electrolyte, a solid electrolyte material is used, such as sulfide solid electrolyte, halogen-based solid electrolyte, oxide solid electrolyte, and polymer solid electrolyte, for example.

When the sulfide solid electrolyte is made of a material capable of conducting lithium ions, a composite (Li₂S—P₂S₅) consisting of lithium sulfide (Li₂S) and phosphorus pentasulfide (P₂S₅) is used, for example. Examples of the sulfide solid electrolyte include sulfides such as Li₂S—P₂S₅, Li₂S—P₂S₅—LiBH₄, Li₇P₃S₁₁, Li₂S—SiS₂, Li₂S—SiS₂—Li₃PO₄, Li₂S—SiS₂—Li₄SiO₄, Li₂S—B₂S₃, Li₂S—GeS₂, Li₆PS₅Cl, LiSiPSCl, and a sulfide containing Li₃N or Li₃N(H). As the sulfide solid electrolyte, a sulfide obtained by adding at least one of Li₃N, LiCl, LiBr, LiI, Li₃PO₄, and Li₄SiO₄ as an additive to the above sulfide may be used. Other specific examples of the sulfide solid electrolytes include Li₁₀GeP₂S₁₂ (LGPS), Na₃Zr₂ (SiO₄)₂PO₄ (NASICON), and the like.

When the oxide solid electrolyte is made of a material capable of conducting lithium ions, Li₇La₃Zr₂O₁₂ (LLZ), Li_{1.3}Al_{0.3}Ti_{1.7}(PO₄)₃(LATP), (La,Li)TiO₃(LLTO) or the like is used, for example.

The halogen-based solid electrolyte is a solid electrolyte containing a halide. The halide is, for example, a compound consisting of Li, M′ and X′. M′ is at least one element selected from the group consisting of a metal element other than Li and a metalloid element. X′ is at least one element selected from the group consisting of F, Cl, Br, and I. The “metal elements” represent all elements (excluding hydrogen) found in Groups 1 to 12 of the periodic table and all elements (excluding B, Si, Ge, As, Sb, Te, C, N, P, O, S, and Se) found in Groups 13 to 16 of the periodic table. The “metalloid elements” represent B, Si, Ge, As, Sb, and Te. For example, M′ may contain Y (yttrium). The halide containing Y may be Li₃ YCl₆ and Li₃ YBr₆.

Examples of other halides include Li₂MgX′₄, Li₂FeX′₄, Li(Al,Ga,In)X′₄, Li₃ (Al,Ga,In)X′₆, LiOX′, and LiX′. To be more specific, examples of the halide include Li₃ InBr₆, Li₃ InCl₆, Li₂FeCl₄, Li₂CrCl₄, Li₃OCl, and LiI.

The polymer solid electrolyte is not particularly limited as long as the solid electrolyte contains an ion-conductive polymer material. Examples of the ion-conductive polymer material include polyether, polyether derivative, polyester, polyimine, and the like.

Besides the solid electrolyte material described above, a thin-film solid electrolyte material such as lithium phosphorus oxynitride (LIPON) may be used as the solid electrolyte.

In the positive electrode layer 10, the volume ratio of the positive electrode active material to the sum of the volume of the positive electrode active material and the volume of the solid electrolyte is, for example, greater than or equal to 30% and less than or equal to 95%. Also, the volume ratio of the solid electrolyte to the sum of the volume of the positive electrode active material and the volume of the solid electrolyte is, for example, greater than or equal to 5% and less than or equal to 70%. When the amount of the positive electrode active material and the amount of the solid electrolyte are in such a volume ratio, it is made easier to ensure a sufficient energy density of the battery 500 and to operate the battery 500 at high output.

As the binder material, the same material as that of a binder used for general solid-state batteries can be used. Examples of the binder material include polyvinylidene fluoride, polytetrafluoroethylene, polyethylene, polypropylene, aramid resin, polyamide, polyimide, polyamideimide, polyacrylonitrile, polyaryl acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, carboxymethylcellulose, polyaniline, polythiophene-styrene-butadiene rubber, polyacrylate, and the like. Alternatively, as the binder material, a copolymer of two or more materials selected from the group consisting of tetrafluoroethylene, hexafluoro ethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene may be used.

Examples of the conductive assistant include graphites such as natural graphite and artificial graphite, carbon blacks such as acetylene black, furnace black, and Ketjen Black (registered trademark), conductive fibers such as VGCF, carbon nanotube, carbon nanofiber, fullerene, carbon fiber, and metal fiber, metal powders such as carbon fluoride and aluminum powder, conductive whiskers such as zinc oxide whisker and potassium titanate whisker, conductive metal oxides such as titanium oxide, conductive polymer compounds such as polyaniline, polypyrrole, and polythiophene, and the like.

The shape of the conductive assistant is, for example, acicular, scale-like, spherical, or oval. The conductive assistant may be particles.

The positive electrode layer 10 has a thickness of, for example, greater than or equal to 10 μm and less than or equal to 500 μm. When the thickness of the positive electrode layer 10 is within such a range, it becomes easier to ensure a sufficient energy density of the battery 500 and to operate the battery 500 at high output. In the present specification, the thickness of each constituent element of the solid-state battery section 100 is the length of each constituent element in the laminating direction.

Examples of a method of forming the positive electrode layer 10 include a method wherein a powdered positive electrode mixture is subjected to uniaxial compression molding, and the like. The positive electrode layer 10 may be formed by applying and drying a paste-like paint containing a positive electrode mixture kneaded together with a solvent on a substrate, the first solid electrolyte layer 30, the positive electrode current collector 60 or the like.

The negative electrode layer 20 is positioned between the negative electrode current collector 70 and the first solid electrolyte layer 30 and is in contact with the negative electrode current collector 70 and the first solid electrolyte layer 30. In addition, a side surface of the negative electrode layer 20 on the structure 200 side is in contact with the second solid electrolyte layer 130, specifically, the first principal surface 130a.

The negative electrode layer 20 contains at least a negative electrode active material. As a material for the negative electrode layer 20, in addition to the negative electrode active material, a negative electrode mixture containing at least one of a solid electrolyte, a conductive assistant, and a binder material may be used as necessary.

The negative electrode active material may be a known material capable of occluding and releasing (inserting and desorbing or dissolving and depositing) metal ions such as lithium ions, sodium ions, magnesium ions, potassium ions, calcium ions, and copper ions. Examples of the negative electrode active material include a metal material, a carbon material, an oxide, a nitride, a tin compound, a silicon compound, and the like.

When the negative electrode active material is a material capable of desorbing and inserting lithium ions, a carbon material such as natural graphite, artificial graphite, graphite carbon fiber or resin-heat-treated carbon, metal lithium, lithium alloy, oxides of lithium and transition metal elements, and the like are used, for example. Examples of metal used in the lithium alloy include indium, aluminum, silicon, germanium, tin, zinc, and the like. Specific examples of the oxides of lithium and transition metal elements include Li₄Ti₅O₁₂, LiₓSiO, and the like.

As the solid electrolyte of the negative electrode layer 20, the solid electrolyte material described above can be used. As the conductive assistant for the negative electrode layer 20, the conductive assistant described above can be used.

As the binder material for the negative electrode layer 20, the binder material described above can be used.

In the negative electrode layer 20, the volume ratio of the negative electrode active material to the sum of the volume of the negative electrode active material and the volume of the solid electrolyte is, for example, greater than or equal to 30% and less than or equal to 95%. Also, the volume ratio of the solid electrolyte to the sum of the volume of the negative electrode active material and the volume of the solid electrolyte is, for example, greater than or equal to 5% and less than or equal to 70%. When the amount of the negative electrode active material particles and the amount of the solid electrolyte are in such a volume ratio, the energy density of the battery 500 can be sufficiently secured, and the battery 500 can be easily operated at high output.

The negative electrode layer 20 has a thickness of, for example, greater than or equal to 10 μm and less than or equal to 500 μm. When the thickness of the negative electrode layer 20 is within such a range, it becomes easier to ensure a sufficient energy density of the battery 500 and to operate the battery 500 at high output.

Examples of a method of forming the negative electrode layer 20 include a method wherein a powdered negative electrode mixture is subjected to uniaxial compression molding, and the like. The negative electrode layer 20 may be formed by applying and drying a paste-like paint containing a negative electrode mixture kneaded together with a solvent on a substrate, the first solid electrolyte layer 30, the negative electrode current collector 70 or the like.

The first solid electrolyte layer 30 is positioned between the positive electrode layer 10 and the negative electrode layer 20 and is in contact with the positive electrode layer 10 and the negative electrode layer 20. In addition, a side surface of the first solid electrolyte layer 30 on the structure 200 side is in contact with the second solid electrolyte layer 130, specifically, the first principal surface 130a.

The first solid electrolyte layer 30 is conductive to metal ions such as lithium ions, sodium ions, magnesium ions, potassium ions, calcium ions, or copper ions. The first solid electrolyte layer 30 may be conductive to lithium ions.

The first solid electrolyte layer 30 contains at least a solid electrolyte and may contain a binder material as necessary. The first solid electrolyte layer 30 may also contain a solid electrolyte conductive to lithium ions.

As the solid electrolyte of the first solid electrolyte layer 30, the solid electrolyte material described above can be used. For the first solid electrolyte layer 30, one type of solid electrolyte may be used, or two or more types of solid electrolytes may be used. As the binder material for the first solid electrolyte layer 30, the binder material described above can be used.

The first solid electrolyte layer 30 has a thickness of, for example, greater than or equal to 0.1 μm and less than or equal to 1000 μm. From the viewpoint of improving the energy density of the battery 500, the first solid electrolyte layer 30 may have a thickness of greater than or equal to 0.1 μm and less than or equal to 50 μm.

Examples of a method of forming the first solid electrolyte layer 30 include a method wherein a powdered material containing the first solid electrolyte layer 30 is subjected to uniaxial compression molding, and the like. The first solid electrolyte layer 30 may be formed by applying and drying a paste-like paint, in which the material containing the first solid electrolyte layer 30 is kneaded together with a solvent, on a substrate, the positive electrode layer 10, the negative electrode layer 20 or the like.

A side surface of the positive electrode layer 10, a side surface of the negative electrode layer 20, and a side surface of the first solid electrolyte layer 30 are flush with each other, and constitute a side surface of the power generating element 50. The side surfaces of the positive electrode layer 10, the negative electrode layer 20, and the first solid electrolyte layer 30 do not have to be flush with each other. For example, the first solid electrolyte layer 30 may cover the side surfaces of the positive electrode layer 10 and the negative electrode layer 20, and the side surface of the power generating element 50 may be configured only by the side surface of the first solid electrolyte layer 30.

The positive electrode current collector 60 is disposed on the side of the positive electrode layer 10 opposite to the first solid electrolyte layer 30 and is in contact with the positive electrode layer 10. The negative electrode current collector 70 is disposed on the side of the negative electrode layer 20 opposite to the first solid electrolyte layer 30 and is in contact with the negative electrode layer 20.

Examples of materials for the positive electrode current collector 60 and the negative electrode current collector 70 include a highly conductive metal material such as copper, aluminum, nickel, iron, stainless steel, platinum, gold, alloys of two or more of these metals or a material obtained by plating of any of these metals. The positive electrode current collector 60 and the negative electrode current collector 70 may be made of the same material, or may be made of different materials.

The shape of the positive electrode current collector 60 and the negative electrode current collector 70 may be set according to the shape of the battery 500 and the like, and thus are not particularly limited. The shape of the positive electrode current collector 60 and the negative electrode current collector 70 is, for example, rod-like, plate-like, sheet-like, foil-like, mesh-like, or the like.

The positive electrode current collector 60 and the negative electrode current collector 70 each have a thickness of, for example, greater than or equal to 1 μm and less than or equal to 10 mm. The thickness of the positive electrode current collector 60 and the negative electrode current collector 70 may be greater than or equal to 1 μm and less than or equal to 50 μm. Alternatively, depending on the shape of the battery 500, the thickness of the positive electrode current collector 60 and the negative electrode current collector 70 may be greater than or equal to 10 mm.

The plan-view shape of each of the positive electrode layer 10, the negative electrode layer 20, the first solid electrolyte layer 30, the positive electrode current collector 60, and the negative electrode current collector 70 is, for example, rectangular, circular, polygonal or the like. For example, the positive electrode layer 10, the negative electrode layer 20, the first solid electrolyte layer 30, the positive electrode current collector 60, and the negative electrode current collector 70 have their outer edges aligned with each other as seen from the laminating direction. Note that the positive electrode layer 10, the negative electrode layer 20, the first solid electrolyte layer 30, the positive electrode current collector 60, and the negative electrode current collector 70 do not have to have their outer edges aligned with each other as seen from the laminating direction.

The structure 200 is provided so as to cover the side surface 100a of the solid-state battery section 100. When the solid-state battery section 100 has a rectangular parallelepiped shape, the structure 200 covers only one side surface 100a of the four side surfaces of the solid-state battery section 100, for example.

In plan view of the side surface 100a of the solid-state battery section 100, the structure 200 does not protrude beyond both ends of the solid-state battery section 100 in the laminating direction of the solid-state battery section 100. In this embodiment, in plan view of the side surface 100a, the outermost periphery of the structure 200 is formed of the outer package 190, and the outer package 190 does not protrude beyond the both ends of the solid-state battery section 100 in the laminating direction of the solid-state battery section 100. The length of the structure 200 in the laminating direction of the solid-state battery section 100 is less than or equal to the length of the solid-state battery section 100 in the laminating direction of the solid-state battery section 100. Thus, even when the solid-state battery section 100 is pressurized in the laminating direction in order to maintain the battery characteristics, the structure 200 is less likely to interfere with the pressurization of the solid-state battery section 100, and the pressurized state of the solid-state battery section 100 is easily maintained. Since deformation of the structure 200 due to the pressurization of the solid-state battery section 100 is suppressed, the reliability of the battery 500 can be improved. In this embodiment, the length of the structure 200 in the laminating direction of the solid-state battery section 100 is the same as the length of the solid-state battery section 100 in the laminating direction of the solid-state battery section 100.

The structure 200 includes the second solid electrolyte layer 130, the reference electrode 110, the reference electrode current collector 170, and the outer package 190. The second solid electrolyte layer 130, the reference electrode 110, and the reference electrode current collector 170 are arranged in this order along the normal direction of the side surface 100a so as to be separated from the side surface 100a.

The shape of the structure 200 is, for example, a rectangular parallelepiped shape, but may be a cylindrical shape, a polygonal prism shape or the like, or may be a shape curved in accordance with the shape of the solid-state battery section 100. Moreover, a convex portion or a concave portion may be formed in part of the surface of the structure 200.

The second solid electrolyte layer 130 is positioned between the reference electrode 110 and the solid-state battery section 100. The second solid electrolyte layer 130 is surrounded by the outer package 190 in plan view of the side surface 100a of the solid-state battery section 100.

On the side surface 100a of the solid-state battery section 100, the second solid electrolyte layer 130 has a first principal surface 130a that is in contact with the power generating element 50 and a second principal surface 130b opposite to the first principal surface 130a. The first and second principal surfaces 130a and 130b are principal surfaces facing back-to-back with each other. The side surface 100a and the first and second principal surfaces 130a and 130b are parallel to each other, for example.

The first principal surface 130a is in contact with more than or equal to two of the plurality of power generating elements 50 on the side surface 100a, for example. In the illustrated example, the first principal surface 130a is in contact with two adjacent power generating elements 50. Thus, the mechanical strength of the second solid electrolyte layer 130 and the bondability between the second solid electrolyte layer 130 and the solid-state battery section 100 are improved. As a result, the reliability of the battery 500 can be improved. The length of the first principal surface 130a in the laminating direction is, for example, greater than twice the thickness of the power generating element 50. Note that the first principal surface 130a may be in contact with only one of the plurality of power generating elements 50. The first principal surface 130a is provided so as to come into contact with the entire power generating element 50 in the laminating direction in the example shown in FIG. 1, but may be in contact with only a part of the power generating element 50 in the laminating direction. For example, the first principal surface 130a may be in contact with at least one of the positive electrode layer 10, the first solid electrolyte layer 30, and the negative electrode layer 20 in the power generating element 50.

To be more specific, the first principal surface 130a is in contact with all of the side surfaces of the positive electrode layer 10, the negative electrode layer 20, and the first solid electrolyte layer 30, which are included in the power generating element 50, on the structure 200 side. The first principal surface 130a may also be in contact with at least one of the positive electrode current collector 60 and the negative electrode current collector 70. In the illustrated example, the first principal surface 130a is in contact with the positive electrode current collector 60 located between the two power generating elements 50 in contact with the first principal surface 130a. The first principal surface 130a may be in contact with at least a part of the power generating element 50 on the side surface 100a.

In plan view of the side surface 100a, the width of the second solid electrolyte layer 130 is smaller than the width of the power generating element 50, and the second solid electrolyte layer 130 is positioned inside both ends of the power generating element 50 in the width direction. Here, the “width” is the length in a direction orthogonal to the laminating direction in plan view of the side surface 100a. Note that both ends of the second solid electrolyte layer 130 in the width direction may coincide with the both ends of the power generating element 50 in the width direction in plan view of the side surface 100a.

The second principal surface 130b is in contact with the reference electrode 110. The second principal surface 130b may also be in contact with the outer package 190.

As a material of the second solid electrolyte layer 130, the same material as that of the first solid electrolyte layer 30 may be used. The same material or different materials may be used for the first and second solid electrolyte layers 30 and 130. One type of solid electrolyte or two or more types of solid electrolytes may be used for the second solid electrolyte layer 130.

The second solid electrolyte layer 130 has a thickness of, for example, greater than or equal to 10 μm and less than or equal to 10 mm. The thickness of the second solid electrolyte layer 130 is, for example, greater than the thickness of the first solid electrolyte layer 30. In the present specification, the thickness of each constituent element of the structure 200 is the length of each constituent element in the normal direction of the side surface 100a of the solid-state battery section 100.

The reference electrode 110 faces the side surface 100a across the second solid electrolyte layer 130. The reference electrode 110 is in contact with the second principal surface 130b of the second solid electrolyte layer 130. Accordingly, the reference electrode 110 is connected in an ion conductive manner to the positive electrode layer 10 and the negative electrode layer 20 through the second solid electrolyte layer 130. Thus, the electrical characteristics of the positive electrode layer 10 and the negative electrode layer 20 can be measured by using the reference electrode 110. The reference electrode 110 is surrounded by the outer package 190 in plan view of the side surface 100a of the solid-state battery section 100.

As shown in FIG. 2B, the area of the reference electrode 110 is smaller than that of the second principal surface 130b in plan view of the second principal surface 130b. The area of the reference electrode 110 in plan view of the second principal surface 130b is the area of the region surrounded by the outer edge of the reference electrode 110 in plan view of the second principal surface 130b. In plan view of the second principal surface 130b, the reference electrode 110 is located inside the outer edge of the second principal surface 130b. That is, in plan view of the second principal surface 130b, the entire reference electrode 110 is provided on a region of the second principal surface 130b and positioned inside the second principal surface 130b. In FIG. 2B, the outer edge of the second principal surface 130b is the portion indicated by the dashed rectangle. Thus, compared to the case where the area of the reference electrode 110 is larger than or equal to the area of the second principal surface 130b, the reference electrode 110 is less likely to come into contact with the solid-state battery section 100. Therefore, short-circuiting between the reference electrode 110 and the solid-state battery section 100 is suppressed. For example, even when the reference electrode 110 and the second solid electrolyte layer 130 are pressed against the solid-state battery section 100 in order to improve the contact between the second solid electrolyte layer 130 and the power generating element 50, the reference electrode 110 is prevented from protruding from the second principal surface 130b and coming into contact with the solid-state battery section 100 due to the pressing force.

In FIG. 2B, the reference electrode 110 is not in contact with the outer edge of the second principal surface 130b in plan view of the second principal surface 130b. Note that the reference electrode 110 may be in contact with a part of the outer edge of the second principal surface 130b as long as the reference electrode does not protrude beyond the outer edge of the second principal surface 130b in plan view of the second principal surface 130b.

As a material of the reference electrode 110, any material can be used without particular limitation as long as the material exhibits an equilibrium potential when in electrochemical contact with the second solid electrolyte layer 130. The reference electrode 110 includes at least one of metallic lithium, a lithium alloy, and a lithium compound, for example. From the viewpoint of measurement accuracy, a material with a small equilibrium potential variation may be used as the material of the reference electrode 110. Examples of the material with a small equilibrium potential variation include metallic lithium, lithium alloys such as In—Li, and lithium compounds such as Li₄Ti₅O₁₂.

The structure 200 has one second solid electrolyte layer 130 and one reference electrode 110, but is not limited to thereto. At least one of the second solid electrolyte layer 130 and the reference electrode 110 in the structure 200 may be provided in a plural number. For example, the structure 200 may have a plurality of second solid electrolyte layers 130. For example, the plurality of second solid electrolyte layers 130 are each arranged so as to come into contact with different power generating elements 50 among the plurality of power generating elements 50. In this case, each individual reference electrode 110 or a common reference electrode 110 may be in contact with the plurality of second solid electrolyte layers 130.

The reference electrode current collector 170 is positioned on the side of the reference electrode 110 opposite to the second solid electrolyte layer 130 and is in contact with the reference electrode 110. For example, the reference electrode current collector 170 covers the entire surface of the reference electrode 110 opposite to the second solid electrolyte layer 130. The position where the reference electrode current collector 170 comes into contact with the reference electrode 110 is not particularly limited, and the reference electrode current collector 170 may be in contact with any surface other than the surface where the reference electrode 110 comes into contact with the second solid electrolyte layer 130.

The surface of the reference electrode current collector 170 opposite to the reference electrode 110 side is exposed to the outside, and is connected to a terminal for extracting a current, for example. Note that the structure 200 may not have the reference electrode current collector 170, and the electrical characteristics may be measured by bringing a terminal or the like into direct contact with the reference electrode 110.

The outer edge of the reference electrode current collector 170 coincides with the outer edge of the reference electrode 110 in plan view of the side surface 100a. That is, the reference electrode current collector 170 and the reference electrode 110 have the same size in plan view of the side surface 100a. In plan view of the side surface 100a, the reference electrode current collector 170 and the reference electrode 110 may have different sizes. For example, the reference electrode current collector 170 may be larger than the reference electrode 110.

Examples of materials for the reference electrode current collector 170 include a highly conductive metal material such as copper, aluminum, nickel, iron, stainless steel, platinum, gold, alloys of more than or equal to two of these metals or a material obtained by plating of any of these metals.

The shape of the reference electrode current collector 170 may be set according to the shape of the structure 200 and the like, and thus is not particularly limited. The shape of the reference electrode current collector 170 is, for example, rod-like, plate-like, sheet-like, foil-like, mesh-like, or the like.

The reference electrode current collector 170 has a thickness of, for example, greater than or equal to 1 μm and less than or equal to 20 mm. In addition, the thickness of the reference electrode current collector 170 is greater than the thicknesses of the second solid electrolyte layer 130 and the reference electrode 110, for example. Depending on the shapes of the battery 500 and the structure 200, the thickness of the reference electrode current collector 170 may be greater than or equal to 10 mm.

In plan view of the side surface 100a, the shapes of the second solid electrolyte layer 130, the reference electrode 110, and the reference electrode current collector 170 are each, for example, rectangular, circular, polygonal or the like.

The outer package 190 covers the side surface of the second solid electrolyte layer 130, which is a surface that connects the outer edge of the first principal surface 130a to the outer edge of the second principal surface 130b. The outer package 190 is in contact with the side surface of the second solid electrolyte layer 130. The side surface of each constituent element in the structure 200 is, for example, a surface parallel to the normal direction of the side surface 100a of the solid-state battery section 100. The outer package 190 does not cover the first principal surface 130a. In plan view of the side surface 100a of the solid-state battery section 100, the outer package 190 surrounds the second solid electrolyte layer 130. In plan view of the side surface 100a of the solid-state battery section 100, the outer package 190 surrounds the entire periphery of the second solid electrolyte layer 130 but is not limited thereto. For example, the outer package 190 may be arranged so as to surround the second solid electrolyte layer 130 at least from both sides in a predetermined direction in plan view of the side surface 100a of the solid-state battery section 100. When the plan-view shape of the second solid electrolyte layer 130 is rectangular, the outer package 190 may surround the second solid electrolyte layer 130 so as to cover, for example, only two opposing sides of the second solid electrolyte layer 130, or only two opposing sides and another side. For example, the outer package 190 may be arranged so as to sandwich the second solid electrolyte layer 130 from both sides in the laminating direction of the solid-state battery section 100.

The outer package 190 partially covers the second principal surface 130b. The outer package 190 is in contact with a portion of the second principal surface 130b where the second principal surface 130b is not in contact with the reference electrode 110. Accordingly, even when the reference electrode 110 and the second solid electrolyte layer 130 are pressed against the side surface 100a, spread of the reference electrode 110 can be suppressed by the outer package 190 covering the second principal surface 130b, and the contact between the reference electrode 110 and the solid-state battery section 100 can be suppressed. The outer package 190 may not cover the second principal surface 130b, and a gap may be provided between the outer package 190 and the reference electrode 110.

The outer package 190 also covers the reference electrode 110 and the reference electrode current collector 170. The outer package 190 is in contact with the reference electrode 110 and the reference electrode current collector 170. In plan view of the side surface 100a of the solid-state battery section 100, the outer package 190 surrounds the reference electrode 110 and the reference electrode current collector 170. Accordingly, the reference electrode 110 and the reference electrode current collector 170 are also protected by the outer package 190. Thus, the mechanical strength of the structure 200 can be further enhanced. Therefore, the reliability of the battery 500 can be further improved. Note that the outer package 190 may not cover at least one of the reference electrode 110 and the reference electrode current collector 170.

The outer package 190 also covers the side surface 100a of the solid-state battery section 100 and is in contact with the side surface 100a. The outer package 190 continuously covers from one end to the other end of the side surface 100a in the laminating direction, for example. Note that the outer package 190 may not cover at least one of one end and the other end of the side surface 100a in the laminating direction.

The outer package 190 has a surface 190a facing the side surface 100a. The surface 190a is in contact with the side surface 100a. The surface 190a is also flush with the first principal surface 130a, for example.

At least a portion of the outer package 190 that is in contact with the solid-state battery section 100, in other words, a portion including the surface 190a is made of an insulating material such as insulating resin or ceramics. A portion of the outer package 190 that is not in contact with the solid-state battery section 100 may be made of the same material as that of the portion that is in contact with the solid-state battery section 100, or may be made of a different material. When the portion that is not in contact with the solid-state battery section 100 is made of a material different from that of the portion that is in contact with the solid-state battery section 100, the portion may be made of a material with higher strength than the portion that is in contact with the solid-state battery section 100. The portion that is not in contact with the solid-state battery section 100 may also be made of a conductive material such as a metal material. In this case, the outer package 190 can also function as a current collector for the reference electrode 110.

The insulating material used for the outer package 190 consists mainly of, for example, insulating resin. The insulating material may further contain various additives and the like for resin. Examples of the insulating resins include epoxy resin, silicone resin, polycarbonate resin, polybutadiene resin, acrylic resin, polyamide resin, polyacetal resin, and the like. The insulating resin may be thermoplastic resin, thermosetting resin or photocurable resin. Although the side surface 100a of the solid-state battery section 100 has fine unevenness derived from the material of each layer of the power generating element 50, the insulating resin contained in the outer package 190 causes a bonding anchor effect between such unevenness and the insulating resin of the outer package 190, making it possible to improve bondability between the solid-state battery section 100 and the structure 200. Therefore, the mechanical strength of the battery 500 is enhanced, and the second solid electrolyte layer 130 is strongly protected by the outer package 190. Thus, the reliability of the battery 500 can be improved.

### Method for Manufacturing Battery

Next, a method for manufacturing the battery 500 according to this embodiment will be described. Note that the method for manufacturing the battery 500 is not limited to the following example.

Examples of the method for manufacturing the battery 500 include a method wherein a solid-state battery section 100 and a structure 200 are separately fabricated and the structure 200 is pressed against the side surface 100a of the solid-state battery section 100.

A solid-state battery section 100 is fabricated first. As a method for fabricating the solid-state battery section 100, a method similar to a general method for manufacturing a battery can be used. For example, first, powders of a material to form a positive electrode layer 10, a material to form a first solid electrolyte layer 30, and a material to form a negative electrode layer 20 are sequentially pressurized and compression-molded to form a power generating element 50. Next, a positive electrode current collector 60 is laminated so as to come into contact with the positive electrode layer 10 in the power generating element 50, and a negative electrode current collector 70 is laminated so as to come into contact with the negative electrode layer 20 in the power generating element 50. Thus, a plurality of unit battery cells 80 are fabricated, each of which is the power generating element 50 having the current collectors laminated therein. By laminating the unit battery cells 80 so as to be electrically connected in parallel, the solid-state battery section 100 is fabricated. Note that the solid-state battery section 100 may be fabricated by a method other than the above method as long as the power generating elements 50 and the current collectors are laminated.

Next, the structure 200 is fabricated. To be more specific, first, an outer package 190 having openings for forming a second solid electrolyte layer 130 and the like is prepared. Then, the second solid electrolyte layer 130 is formed by pressurizing and compression-molding a material to form the second solid electrolyte layer 130 in the opening of the outer package 190. Thereafter, a reference electrode 110 is disposed or a material to form the reference electrode 110 is pressurized and compression-molded on a second principal surface 130b of the second solid electrolyte layer 130 thus formed. A reference electrode current collector 170 is further disposed on the reference electrode 110 thus formed to fabricate the structure 200. Note that the method for fabricating the structure 200 is not limited to the above method. For example, the structure 200 may be fabricated by forming the outer package 190 by sandwiching a laminate of the second solid electrolyte layer 130, the reference electrode 110, and the reference electrode current collector 170 with insulating resin sheets or the like.

Next, by pressing the first principal surface 130a of the second solid electrolyte layer 130 in the structure 200 against the side surface 100a of the solid-state battery section 100 and bringing the first principal surface 130a into contact with the power generating element 50, the battery 500 can be manufactured.

In another manufacturing method, after a solid-state battery section 100 is fabricated by the above method or the like, a second solid electrolyte layer 130 is formed on the side surface 100a so as to be in contact with the power generating element 50 and a reference electrode 110 is formed on the second principal surface 130b of the second solid electrolyte layer 130 thus formed. A reference electrode current collector 170 is further disposed on the formed reference electrode 110. Next, an insulating resin or the like is applied to the side surface 100a of the solid-state battery section 100 to form the outer package 190 so as to surround and cover the second solid electrolyte layer 130, the reference electrode 110, and the reference electrode current collector 170. Thus, the battery 500 may be manufactured by fabricating the structure 200 directly on the side surface 100a.

In the case of this manufacturing method, the bondability between the structure 200 and the solid-state battery section 100 is improved by the bonding anchor effect between the insulating resin and the fine unevenness derived from the constituent elements of each layer in the power generating element 50 on the side surface 100a of the solid-state battery section 100. As a result, the second solid electrolyte layer 130 and the power generating element 50 can firmly form and maintain electrochemical contact.

### Method for Measuring Electrical Characteristics of Battery

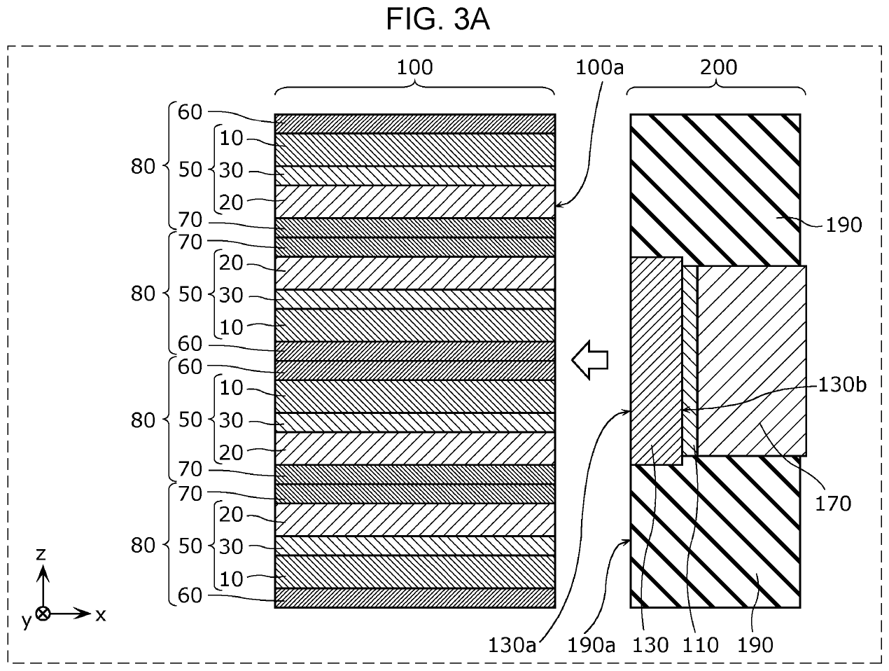

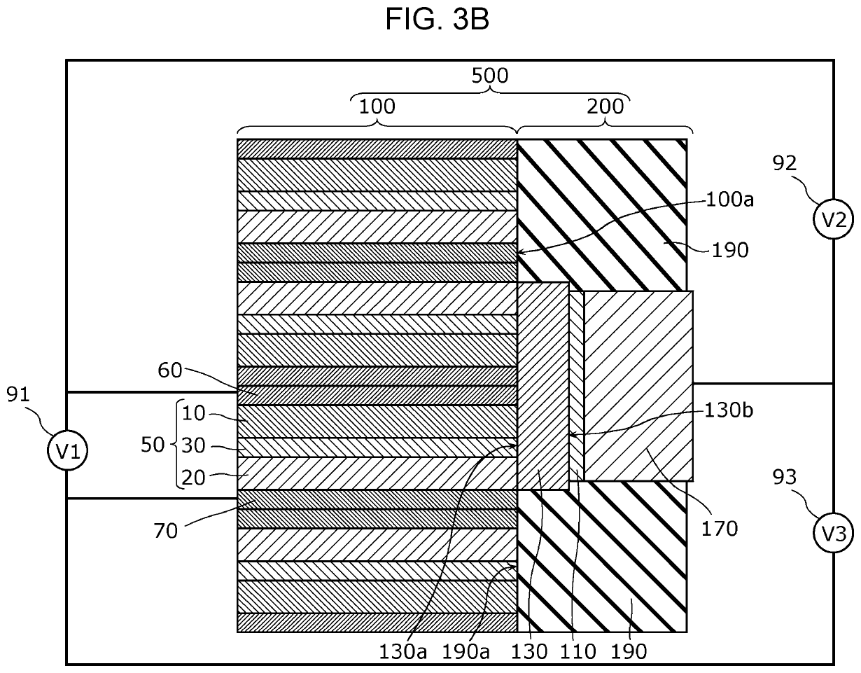

Next, a method for measuring electrical characteristics of the battery 500 according to this embodiment will be described. To be more specific, a method for measuring electrical characteristics of the battery 500 including the power generating element 50 will be described with reference to FIGS. 3A and 3B.

FIGS. 3A and 3B is a diagram for explaining the method for measuring the electrical characteristics of the battery 500.

As shown in FIG. 3A, first, a solid-state battery section 100 having a plurality of power generating elements 50 laminated therein and a structure 200 are prepared using the manufacturing method described above or the like. Then, a first principal surface 130a of a second solid electrolyte layer 130 is brought into contact with at least one power generating element 50 on the side surface 100a of the solid-state battery section 100. For example, by pressing the structure 200 against the side surface 100a of the solid-state battery section 100, the first principal surface 130a of the second solid electrolyte layer 130 is brought into contact with at least one power generating element 50. Thus, a battery 500 is formed as shown in FIG. 3B.

Then, as shown in FIG. 3B, for example, a voltage measuring device 91 is electrically connected to a positive electrode layer 10 and a negative electrode layer 20 in one of the power generating elements 50 in contact with the first principal surface 130a of the second solid electrolyte layer 130 through a positive electrode current collector 60 and a negative electrode current collector 70. A voltage measuring device 92 is electrically connected to the positive electrode layer 10 and the reference electrode 110 through the positive electrode current collector 60 and the reference electrode current collector 170. A voltage measuring device 93 is electrically connected to the negative electrode layer 20 and the reference electrode 110 through the negative electrode current collector 70 and the reference electrode current collector 170. Thus, a voltage V1 between the positive electrode layer 10 and the negative electrode layer 20, a voltage V2 between the positive electrode layer 10 and the reference electrode 110, and a voltage V3 between the negative electrode layer 20 and the reference electrode 110 can be measured. Accordingly, electrical characteristics are measured, such as the voltage between at least one of the positive electrode layer 10 and the negative electrode layer 20 and the reference electrode 110. Also, as the electrical characteristic, electrical characteristics other than the voltage, such as impedance, may be measured.

In this event, regardless of operations of the positive electrode layer 10 and the negative electrode layer 20, the reference electrode 110 exhibits a constant value as an equilibrium potential with the second solid electrolyte layer 130. Thus, the potential of the positive electrode layer 10 and/or the negative electrode layer 20 can be measured as a voltage difference between the reference electrode 110 and the positive electrode layer 10 and/or the negative electrode layer 20.

### Effects or the Like

As for a solid-state battery having a reference electrode of the related art, various structures have been studied as disclosed in “Q & A de Rikaisuru Denkikagaku no Sokutei Hou (Understanding of Electrochemical Measurement Method with Q & A)” edited by The Electrochemical Society of Japan, published by Mimizuku-sha in December 2009, p. 10. However, the structure thereof is complicated, and it is not easy to form the structure.

The solid-state battery having a reference electrode disclosed in Japanese Unexamined Patent Application Publication No. 2013-20915 has a structure in which a positive electrode, a solid electrolyte layer, and a negative electrode are laminated and a third electrode is provided as a reference electrode that is in contact with a solid electrolyte section provided so as to connect with a width that matches the length of the side surface of the solid electrolyte layer or the positive electrode, the solid electrolyte layer, and the negative electrode. In this solid-state battery, the potential of the positive electrode and/or the negative electrode can be measured.

However, in the structure described in Japanese Unexamined Patent Application Publication No. 2013-20915, the solid electrolyte layer and the reference electrode in the reference electrode section have the same width, and when the reference electrode is pressed against the solid-state battery for stable potential measurement, the reference electrode may protrude from the solid electrolyte layer and come into contact with the solid-state battery, possibly causing short-circuiting.

In this embodiment, in plan view of the second principal surface 130b, the area of the reference electrode 110 is smaller than the area of the second principal surface 130b, and the reference electrode 110 is positioned on the inner side than the outer edge of the second principal surface 130b. Thus, the reference electrode 110 is less likely to come into contact with the solid-state battery section 100, compared to the case where the area of the reference electrode 110 is larger than or equal to the area of the second principal surface 130b. Also when pressure is applied to improve the contact between the second solid electrolyte layer 130 and the side surface 100a of the solid-state battery section 100, the reference electrode 110 is less likely to come into contact with the solid-state battery section 100. Thus, short-circuiting can be prevented.

In this embodiment, for three-electrode measurement, the second solid electrolyte layer 130 in contact with the power generating element 50 does not have to have a structure in which the length of the first principal surface 130a precisely matches the length of the side surface of the power generating element 50 in the laminating direction of the solid-state battery section 100 but may have any structure that allows electrochemical contact with the power generating element 50.

Therefore, as shown in FIG. 1, the battery 500 includes the solid-state battery section 100 in which the plurality of power generation element 50 are electrically connected in parallel and laminated, and the structure 200 including the reference electrode 110 and the second solid electrolyte layer 130. By pressing the structure 200 against the side surface 100a of the solid-state battery section 100, the first principal surface 130a and the power generating element 50 can be brought into contact with each other. Therefore, the electrical characteristics of the positive electrode layer 10 and/or the negative electrode layer 20 can be easily measured.

As shown in FIG. 1, the first principal surface 130a of the second solid electrolyte layer 130 may be in contact with more than or equal to two of the plurality of power generating elements 50 on the side surface 100a of the solid-state battery section 100. Accordingly, the first principal surface 130a can be enlarged, and thus contact between the power generating element 50 and the second solid electrolyte layer 130 can be formed on the side surface 100a without precise alignment. Therefore, the battery 500 can be easily formed. Moreover, since the contact area between the first principal surface 130a and the side surface 100a is increased, the second solid electrolyte layer 130 is less likely to come off the solid-state battery section 100. As a result, the durability of the battery 500 can be enhanced. Moreover, the structure 200 can be fabricated with a degree of dimensional accuracy that allows the length of the first principal surface 130a to be larger than the length of more than or equal to two laminated power generating elements 50 in the laminating direction, so that the first principal surface 130a is easily brought into contact with the power generating element 50 in fabrication of the structure 200.

In the structure 200, the second solid electrolyte layer 130 and the reference electrode 110 are covered with the outer package 190. Thus, the mechanical strength is increased, and the reliability of the battery 500 can be improved. Even when the battery 500 is housed in a thin outer package such as a laminate film, the shapes of the second solid electrolyte layer 130 and the reference electrode 110 in the structure 200 are maintained. As a result, stable potential measurement can be performed.

For these reasons, in the battery 500, short-circuiting between the reference electrode 110 and the solid-state battery section 100 can be suppressed. In addition, it is possible to manufacture the battery 500 in which the electrical characteristics can be measured, such as the potential of the positive electrode layer 10 and/or the negative electrode layer 20 in at least one of the plurality of laminated power generating elements 50. Therefore, according to this embodiment, a highly reliable battery 500 can be realize, in which the electrical characteristics of the electrodes can be measured.

Since the potential of the positive electrode layer 10 and/or the negative electrode layer 20 alone can be measured using the battery 500 according to this embodiment, the electrical characteristics of the positive electrode layer 10 and/or the negative electrode layer 20 can be determined in the development of batteries. At the same time, the electrical characteristics can be measured separately from the positive electrode layer 10 and the negative electrode layer 20. Therefore, the development and design of batteries can be effectively and efficiently promoted.

When the battery 500 according to this embodiment applied to and developed as a practical battery, the following effects can be realized, for example. In the positive electrode layer 10, when the structure of the active material changes at a certain potential or higher, for example, and the electrode performance such as charge/discharge capacity and cycle characteristics deteriorates, the potential of the positive electrode layer 10 can be monitored and controlled so as not to exceed the certain potential. As a result, in the battery 500, deterioration in electrode performance due to charging can be suppressed. As for the negative electrode layer 20, in the case of an electrode that is used up to near a deposition potential of metallic lithium during charging, for example, metallic lithium deposition can be suppressed by monitoring and controlling the potential so as not to reach the deposition potential of metallic lithium (for example, lower than or equal to 0 V, vs. Li+/Li). As a result, in the battery 500, it is possible to prevent shortening of the battery life due to a decrease in charge/discharge capacity and cycle deterioration, and to reduce the risk of short-circuit phenomenon, heating, and ignition due to deposition of metallic lithium.

### Modified Example 1

Next, modified example 1 of the embodiment will be described. In the following description of the modified example, differences from the embodiment will be mainly described, and description of similarities will be omitted or simplified.

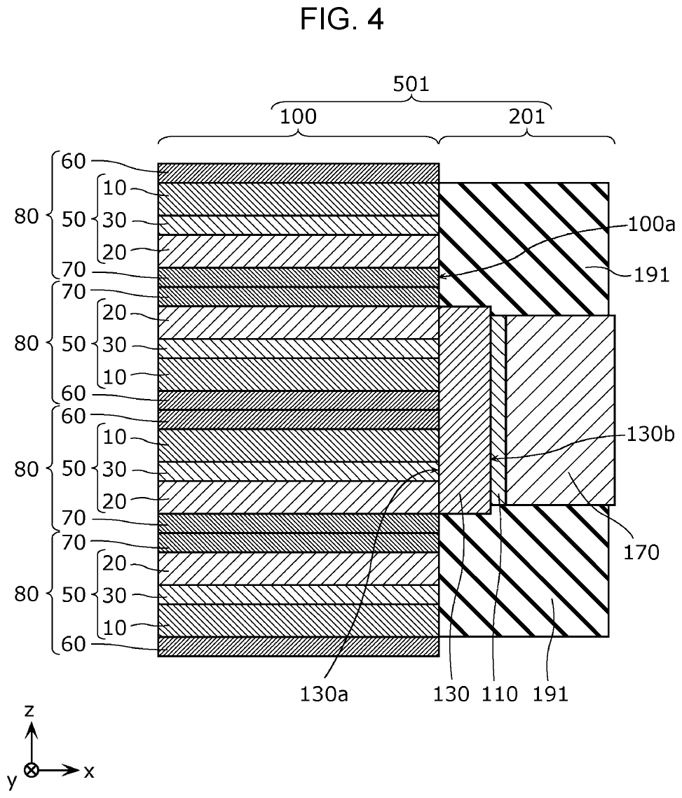

FIG. 4 is a cross-sectional view showing a schematic configuration of a battery 501 according to this modified example.

As shown in FIG. 4, the battery 501 is different from the battery 500 according to the embodiment in including a structure 201 instead of the structure 200.

The structure 201 includes a second solid electrolyte layer 130, a reference electrode 110, a reference electrode current collector 170, and an outer package 191. The structure 201 has the same configuration as that of the structure 200 except that its width in the laminating direction of the solid-state battery section 100 is smaller than that of the structure 200.

In plan view of the side surface 100a of the solid-state battery section 100, the structure 201 does not protrude beyond both ends of the solid-state battery section 100 in the laminating direction of the solid-state battery section 100. In addition, the length of the structure 201 in the laminating direction of the solid-state battery section 100 is shorter than the length of the solid-state battery section 100 in the laminating direction of the solid-state battery section 100. That is, in plan view of the side surface 100a of the solid-state battery section 100, the entire structure 201 is positioned on the inner side than both ends of the solid-state battery section 100 in the laminating direction. In this modified example, in plan view of the side surface 100a, the outermost periphery of the structure 201 is formed of the outer package 191, and the entire outer package 191 is located on the inner side than the both ends of the solid-state battery section 100 in the laminating direction. Thus, even when the solid-state battery section 100 is pressurized in the laminating direction for use, the structure 201 is less likely to interfere with the pressurization of the solid-state battery section 100. Thus, the reliability of the battery 501 can be improved. Even when the solid-state battery section 100 is compressed in the laminating direction by the pressurization of the solid-state battery section 100 in the laminating direction, the structure 201 positioned on the inner side than the solid-state battery section 100 is less likely to hinder the compression of the solid-state battery section 100. Thus, battery characteristics of the solid-state battery section 100 can be improved. Modified Example 2

Next, modified example 2 of the embodiment will be described. In the following description of the modified example, differences from the embodiment will be mainly described, and description of similarities will be omitted or simplified.

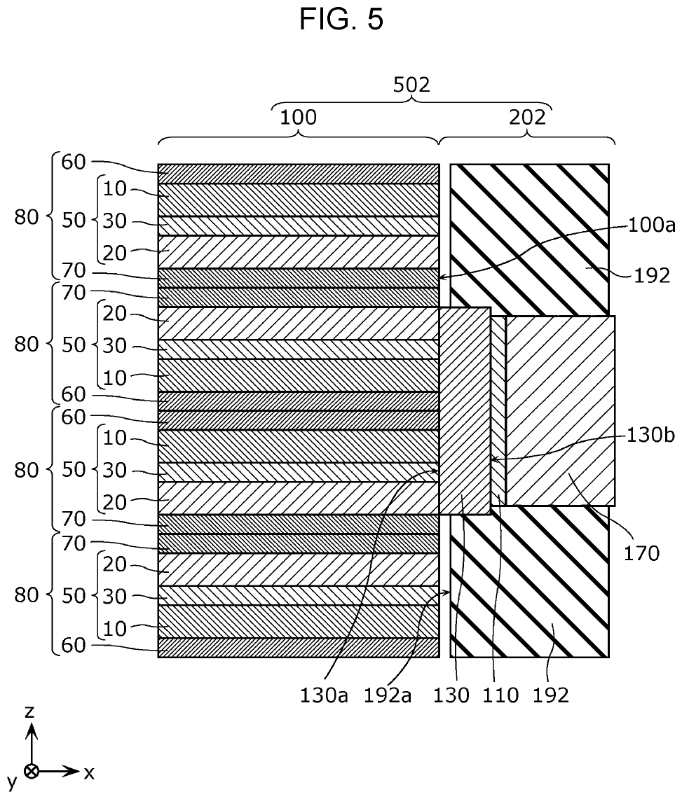

FIG. 5 is a cross-sectional view showing a schematic configuration of a battery 502 according to this modified example.

As shown in FIG. 5, the battery 502 is different from the battery 500 according to the embodiment in including a structure 202 instead of the structure 200.

The structure 202 includes a second solid electrolyte layer 130, a reference electrode 110, a reference electrode current collector 170, and an outer package 192.

The outer package 192 has a surface 192a facing a side surface 100a of a solid-state battery section 100. The second solid electrolyte layer 130 protrudes from the surface 192a, and a first principal surface 130a at a position protruding from the surface 192a is in contact with the side surface 100a. The side surface 100a and the surface 192a are not in contact with each other, and the outer package 192 and the solid-state battery section 100 are separated from each other.

Thus, since the second solid electrolyte layer 130 protrudes from the surface 192a, the outer package 192 is less likely to hinder the contact between the first principal surface 130a and the side surface 100a. As a result, the contact between the first principal surface 130a and the side surface 100a can be improved. For example, even when the side surface 100a has fine unevenness, the force of pressing the structure 200 against the side surface 100a easily acts between the first principal surface 130a and the side surface 100a. Accordingly, electrochemical contact is easily formed between the power generating element 50 and the second solid electrolyte layer 130. Therefore, the accuracy of electrical characteristics measurement using the reference electrode 110 can be improved.

### Modified Example 3

Next, modified example 3 of the embodiment will be described. In the following description of the modified example, differences from the embodiment will be mainly described, and description of similarities will be omitted or simplified.

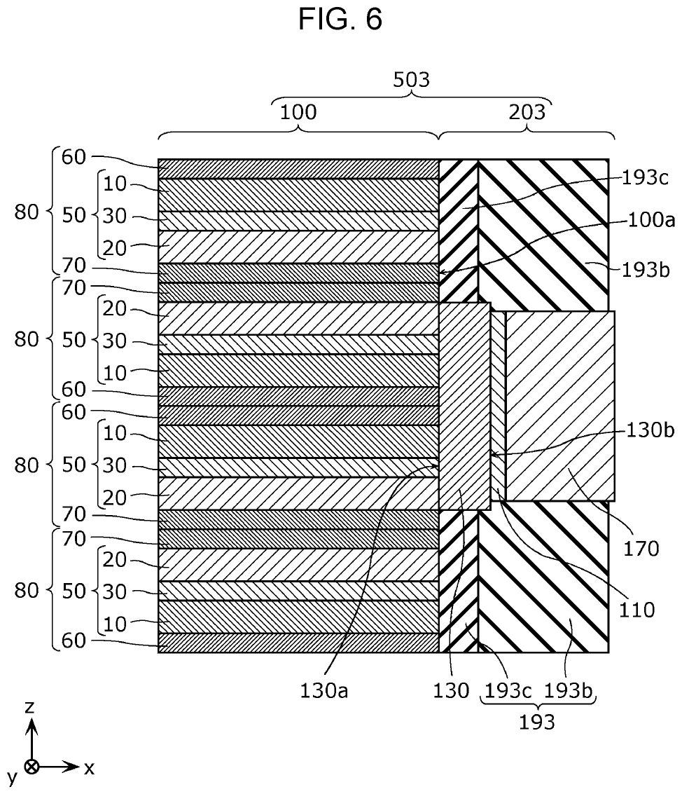

FIG. 6 is a cross-sectional view showing a schematic configuration of a battery 503 according to this modified example.

As shown in FIG. 6, the battery 503 is different from the battery 500 according to the embodiment in including a structure 203 instead of the structure 200.

The structure 203 includes a second solid electrolyte layer 130, a reference electrode 110, a reference electrode current collector 170, and an outer package 193.

The outer package 193 includes a first resin layer 193b and a second resin layer 193c.

The first resin layer 193b faces a solid-state battery section 100 with the second resin layer 193c interposed therebetween. The first resin layer 193b covers a portion of the second solid electrolyte layer 130 that is not covered with the second resin layer 193c, that is, the reference electrode 110 and the reference electrode current collector 170. The first resin layer 193b contains a first insulating resin. The first resin layer 193b is made of an insulating material that consists mainly of the first insulating resin, for example. As the first insulating resin, the insulating resin mentioned as the insulating resin used for the outer package 190 is used, for example.

The second resin layer 193c is positioned between the first resin layer 193b and the solid-state battery section 100. The second resin layer 193c is in contact with a side surface 100a of the solid-state battery section 100. The second resin layer 193c covers a side surface of the second solid electrolyte layer 130 and is in contact with the side surface. Since the second resin layer 193c continuously covers the side surface 100a of the solid-state battery section 100 and the side surface of the second solid electrolyte layer 130, the second solid electrolyte layer 130 can be effectively protected.

The second resin layer 193c is softer than the first resin layer 193b. For example, the second resin layer 193c has an elastic modulus lower than that of the first resin layer 193b. Therefore, the second resin layer 193c, which is softer and more easily deformable than the first resin layer 193b, is in contact with the side surface 100a of the solid-state battery section 100. Thus, the outer package 193 is less likely to hinder the contact between the first principal surface 130a and the side surface 100a. As a result, the contact between the first principal surface 130a and the side surface 100a can be improved. The second resin layer 193c may be softer than the second solid electrolyte layer 130. For example, the second resin layer 193c may have an elastic modulus lower than that of the second solid electrolyte layer 130. Therefore, even when the side surface 100a has fine unevenness, for example, the second resin layer 193c is more easily deformed than the second solid electrolyte layer 130. Thus, the force pressing the structure 200 against the side surface 100a more easily acts between the first principal surface 130a and the side surface 100a. Accordingly, electrochemical contact is easily formed between the solid-state battery section 100 and the second solid electrolyte layer 130.

The second resin layer 193c contains a second insulating resin. The second resin layer 193c is made of an insulating material that consists mainly of the second insulating resin, for example. As the second insulating resin, a resin having an elastic modulus lower than that of the first insulating resin is used, for example. As the second insulating resin, a rubber-based or elastomer-based insulating resin is used, for example. As the second insulating resin, the insulating resin mentioned as the insulating resin used for the outer package 190 may be used.

Alternatively, the second resin layer 193c may be made of a porous material that consists mainly of the second insulating resin. In this case, the second insulating resin may be the same resin as the first insulating resin or may be a resin having an elastic modulus higher than that of the first insulating resin.

### Modified Example 4

Next, modified example 4 of the embodiment will be described. In the following description of the modified example, differences from the embodiment will be mainly described, and description of similarities will be omitted or simplified.

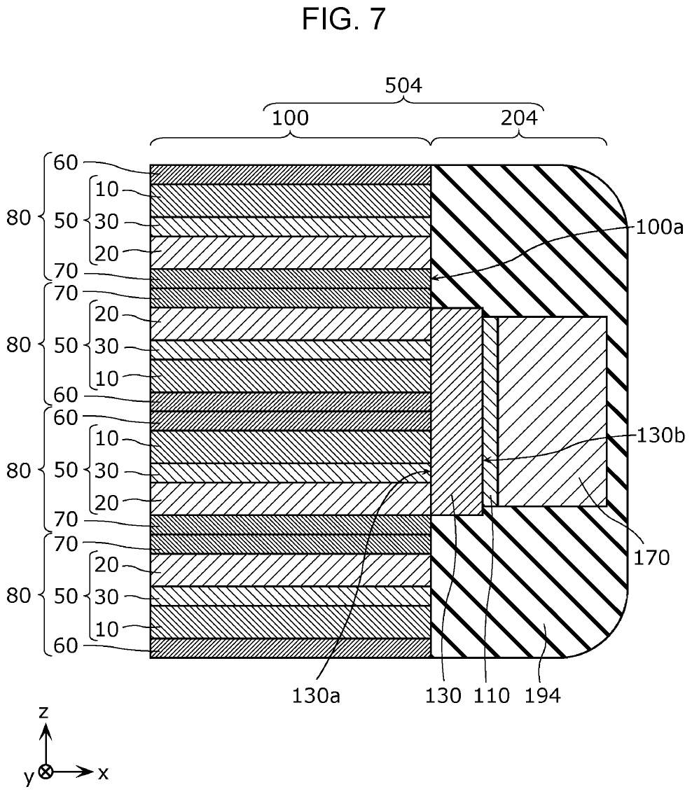

FIG. 7 is a cross-sectional view showing a schematic configuration of a battery 504 according to this modified example.

As shown in FIG. 7, the battery 504 is different from the battery 500 according to the embodiment in including a structure 204 instead of the structure 200.

The structure 204 includes a second solid electrolyte layer 130, a reference electrode 110, a reference electrode current collector 170, and an outer package 194.

The outer package 194 covers the second solid electrolyte layer 130, the reference electrode 110, and the reference electrode current collector 170. The outer package 194 covers the reference electrode current collector 170 from the side of the reference electrode 110 opposite to the solid-state battery section 100 side. Therefore, the outer package 194 covers a side surface of the second solid electrolyte layer 130, a side surface of the reference electrode 110, a side surface of the reference electrode current collector 170, and a principal surface of the reference electrode current collector 170 opposite to the solid-state battery section 100 side. The outer package 194 and the solid-state battery section 100 are arranged so as to sandwich the second solid electrolyte layer 130, the reference electrode 110, and the reference electrode current collector 170. The second solid electrolyte layer 130, the reference electrode 110, and the reference electrode current collector 170 are entirely wrapped by the outer package 194 and the solid-state battery section 100. Therefore, since the second solid electrolyte layer 130, the reference electrode 110, and the reference electrode current collector 170 are covered with the outer package 194 in contact with the side surface 100a of the solid-state battery section 100, contact between the second solid electrolyte layer 130 and the power generating element 50 is firmly maintained. Thus, electrical characteristics of each layer can be stably measured. Particularly, when the outer package 194 contains an insulating resin, the bonding anchor effect can be exerted at a portion where the insulating resin is in contact with the side surface 100a. Thus, the contact between the second solid electrolyte layer 130 and the power generating element 50 is more firmly maintained.

Although not shown, in the battery 504, a lead wire or the like that penetrates the outer package 194, for example, is connected to the reference electrode current collector 170. Thus, the reference electrode 110 is electrically connected to the outside.

### OTHER EMBODIMENTS

The battery according to the present disclosure has been described above based on the embodiment and modified examples, but the present disclosure is not limited to these embodiment and modified examples. Variations of the embodiment and modified examples that would be conceived by those skilled in the art, and other forms constructed by combining some of the constituent elements in the embodiment and modified examples are also included in the scope of the present disclosure without departing from the gist of the present disclosure.

For example, the solid-state battery section 100 has the structure in which the plurality of power generating elements 50 are laminated in the above embodiment, but the present disclosure is not limited thereto. The solid-state battery section 100 may be configured to include one power generating element 50.

For example, the plurality of power generating elements 50 are electrically connected in parallel and laminated in the above embodiment, but the present disclosure is not limited thereto. The plurality of power generating elements 50 may be electrically connected in series and laminated. That is, the plurality of power generating elements 50 may be laminated such that electrodes of different polarities in adjacent power generating elements 50 are electrically connected. In this case, the first principal surface 130a of the second solid electrolyte layer 130 is in contact with only one of the plurality of power generating elements 50, in order to avoid ion conductive short-circuiting. The plurality of power generating elements 50 may be connected by combining series connection and parallel connection.

The features of the structures according to the above modified examples may be combined. For example, the structure 201 may have a structure in which the second solid electrolyte layer 130 protrudes as in the structure 202, or may be configured to include the first resin layer 193b and the second resin layer 193c as in the structure 203. Alternatively, as in the structure 204, the reference electrode current collector 170 may be covered with the outer package from the side of the reference electrode 110 opposite to the solid-state battery section 100 side. The same applies to the structures 202 to 204.

Various changes, replacement, addition, omission, and the like can be made to the above embodiment and modified examples within the scope of claims or equivalent thereof.

The battery according to the present disclosure can be used for monitoring, design or development of electrodes, and the like. Also, the battery according to the present disclosure can be used for electronic devices, electric appliances, electric vehicles, and the like as a battery in which the electrical characteristics of the electrodes can be measured.

What is claimed is:

1. A battery comprising:
a solid-state battery section having at least one power generating element including a first electrode layer, a second electrode layer, and a first solid electrolyte layer positioned between the first electrode layer and the second electrode layer; and
a structure including a second solid electrolyte layer having a first principal surface in contact with the at least one power generating element on a side surface of the solid-state battery section and a second principal surface opposite to the first principal surface, and a reference electrode in contact with the second principal surface.

2. The battery according to claim 1, wherein
the reference electrode is smaller in area than the second principal surface in plan view of the second principal surface.

3. The battery according to claim 1, wherein
the at least one power generating element includes a plurality of power generating elements,
the solid-state battery section has a structure in which the plurality of power generating elements are laminated, and
the structure further includes an outer package which covers a side surface of the second solid electrolyte layer.

4. The battery according to claim 3, wherein
the outer package has a surface facing the side surface of the solid-state battery section, and the second solid electrolyte layer protrudes from the surface.

5. The battery according to claim 3, wherein
the outer package contains insulating resin and is in contact with the side surface of the solid-state battery section.

6. The battery according to claim 5, wherein
the outer package includes a first resin layer that contains a first insulating resin and a second resin layer that contains a second insulating resin and is softer than the first resin layer, and
the second resin layer is positioned between the first resin layer and the solid-state battery section and is in contact with the side surface of the solid-state battery section.

7. The battery according to claim 3, wherein
the plurality of power generating elements are electrically connected in parallel and laminated, and
the first principal surface is in contact with more than or equal to two of the plurality of power generating elements.

8. The battery according to claim 3, wherein
the outer package partially covers the second principal surface.

9. The battery according to claim 3, wherein
the structure further includes a reference electrode current collector in contact with the reference electrode, and
the outer package covers the reference electrode and the reference electrode current collector.

10. The battery according to claim 1, wherein
the structure does not protrude beyond both ends of the solid-state battery section in the laminating direction of the solid-state battery section in plan view of the side surface of the solid-state battery section.

11. The battery according to claim 10, wherein
a length of the structure in the laminating direction of the solid-state battery section is smaller than a length of the solid-state battery section in the laminating direction of the solid-state battery section.
